(19) United States
(12) Patent Application Publication
(10) Pub. No.: US 2003/0195965 A1
(43) Pub. Date: Oct. 16, 2003

(54) Data communication method using resource reservation

(76) Inventors: Il-Gyu Choi, Shihung-shi (KR); Byung-Gu Choe, Seoul (KR)

Correspondence Address: Robert E. Bushnell, 1522 K Street, N.W., Suite 300, Washington, DC, 20005-1202, US

(21) Appl. No.: 10/368,419

(22) Filed: Feb. 20, 2003

(30) Foreign Application Priority Data
Apr. 11, 2002 (KR) 2002-19816

(51) Int. Cl. G06F 15/16

(52) U.S. Cl. 709/227

(57) ABSTRACT

A data communication method is capable of preventing an endless repetition of a resource reservation procedure due to the change of a link state in a communication network using a resource reservation protocol. The method includes the steps of starting a timer set for a predetermined time period when a link resource for data transmission from a sender to a receiver is reserved in the communication network, determining whether the timer is in operation when the link state of the communication network is changed after the resource is reserved, ignoring the change of the link state and continuing the data transmission when the timer is determined to be in operation, and again reserving the link resource for the data transmission when the timer is determined to be not in operation.

### CLAIM OF PRIORITY

This application makes reference to, incorporates the same herein, and claims all benefits accruing under 35 U.S.C. §119 from my application DATA COMMUNICATION METHOD USING RESOURCE RESERVATION filed with the Korean Industrial Property Office on Apr. 11, 2002 and there duly assigned Serial No. 2002-19816.

### BACKGROUND OF THE INVENTION

1. Technical Field

The present invention relates to a data communication method, and more particularly to a data communication method using a resource reservation protocol in a communication network.

2. Related Art

In a communication network such as the Internet, information such as text, music, images, etc. may be transmitted among interconnected communication devices. Such information is split into small data packets according to a protocol such as an Internet protocol (IP), etc., and then transmitted through the network. The respective data packets are transferred to a destination through a plurality of network transmission devices, called routers, in the network.

The data packets as above may be delayed in transmission or lost depending on whether the routers have resources (for instance, bandwidth, delay, etc.) that support the corresponding data packets. Recently, with an explosive increase in user demand and diversity of service applications, reliability in data transmission and security in the quality of service (QoS) have been required, and many schemes for satisfying such demands have been proposed accordingly. The resource reservation protocol (RSVP) is a network control protocol proposed to support such a QoS service, and its function has been continuously improved.

The RSVP is a protocol for reserving resources required for data flow on a selected path, but it does not support a routing process. The routing process is a process that searches for an optimum path to a specified destination using collected information on the basis of the physical characteristic (for instance, bandwidth, delay, etc.) of the network, the characteristic of a routing protocol being used, the network application policy, etc. In other words, the resource reservation by the RSVP is performed on a path that has already been selected by the routing process of the routers located between a sender and a receiver.

In data flow performed in a typical network using the routing protocol with the RSVP, a sender, for instance, requests a resource reservation of 10 Mbps to the receiver. This request for resource reservation is performed through all possible paths from the sender to the receiver, for example, through an A path and a B path. Numerals are indicated among routers, 20M, 15M, 13M, 25M, and 19M on the A path, and 20M, 10M, 9M, 10M, and 19M on the B path, to mean available resource information (i.e., bandwidth and Mbps) in links among the corresponding routers.

The receiver selects the A path with reference to the available resource information of the routers on all of the paths, and informs the sender that resource reservation of 10 Mbps is possible through the A path. Then, the routers R1 , R2, R3, and R4 on the A path set the resource reservation to as much as 10 Mbps. The sender determines whether the use of the requested resource is possible, and thus starts to transmit data packets through the A path.

During the above-described data flow, if the routers R1, R2, R3, and R4 on the A path set the resource reservation, the link states (i.e., bandwidths) are changed to 10M, 5M, 3M, 15M, and 9M. In a typical communications network, it is known that routers support an open shortest path first protocol (OSPF). According to this OSPF, a router that detects the change of a routing table or variation in a network immediately informs all the routers in the same area of this fact so that the routers have the same routing table information.

Then, the routers R1, R2, R3, and R4 inform other routers of the change of the link state, the other routers including the sender and the receiver, in accordance with the OSPF. Due to this change of the link state, the B path (but not the A path) can be selected as an optimum path between the sender and the receiver. Then, the sender receives the change of link state and again requests the resource reservation of 10 Mbps to the receiver in order to re-perform the resource reservation procedure.

The receiver selects the B path in response to the second request for resource reservation, and reports that the resource reservation is possible in a direction opposite to that of the B path using a RESV message. Then, the routers R1, R6, R7, and R4 on the B path set the resource reservation to as much as 10 Mbps, and the sender determines whether the use of the requested resource is possible, and transmits the data packets through the B path. During this procedure, the reserved resources on the A path are withdrawn.

Then, the routers R1, R6, R7, and R4 on the B path set the resource reservation, and subsequently report the change of the link state in accordance with the OSPF, while the routers R1, R2, R3, and R4 on the A path report the change of the link state. As a result, an unnecessary repetition of the resource reservation procedure (i.e., a ping-pong phenomenon) may be endlessly repeated.

### SUMMARY OF THE INVENTION

Accordingly, the present invention has been made to solve the above-mentioned problems occurring in the prior art, and an object of the present invention is to provide a data communication method and apparatus which can avoid the ping-pong phenomenon that may be generated during selection of a path in a communication network using a resource reservation protocol (RSVP).

It is another object of the present invention to provide a data communication method and apparatus which can prevent endless repetition of a resource reservation procedure when an RSVP is used in a communication network that supports an open shortest path first (OSPF) protocol.

In order to accomplish the above objects, there is provided a method of performing data communication using a resource reservation in a communication network, the method comprising a first step of starting a timer set for a predetermined time when a link resource for data transmission from a sender to a receiver is reserved in the communication network, a second step of checking whether the timer is in operation if a link state of the communication network is changed after the resource is reserved, a third step of ignoring the change of the link state and continuing the data transmission if the timer is found to be in operation as a result of checking, and a fourth step of reserving again the link resource for the data transmission if the timer is found to not be in operation as a result of checking.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 is a view illustrating a message flow for requesting a resource reservation between a sender and a receiver.

FIG. 2 is a view illustrating a message flow for responding to the request for resource reservation as shown in FIG. 1.

FIG. 3 is a view illustrating a message flow for responding to the request for resource reservation as shown in FIG. 1 with reflection of a link state changed according to an open shortest path first protocol (OSPF).

FIG. 4 is a block diagram illustrating the internal construction of a router in a communication network that supports a resource reservation protocol (RSVP).

FIG. 5 is a flowchart illustrating a procedure for performing data communication using an RSVP according to the present invention.

### DETAILED DESCRIPTION OF THE PREFERRED EMBODIMENT

Hereinafter, the data communication method and apparatus using an RSVP in a communication network according to a preferred embodiment of the present invention will be described with reference to the accompanying drawings. In the following description of the present invention, a detailed description of known functions and configurations incorporated herein will be omitted when it may make the subject matter of the present invention unclear. Also, terms to be described later are defined considering their functions in the present invention, and can be changed according to the intention of a user or custom. Thus, they shall be defined based on the contents throughout this specification.

The present invention uses a resource reservation protocol (RSVP) to support the quality of service (QoS), and is applied to a communication network that drives an open shortest path first (OSPF) protocol as a routing protocol.

The routing protocol enables the respective routers to determine which router the path information is transferred to in order to transfer the packets to a destination, and transfers the packets according to the path information. In particular, the OSPF is a link-state routing protocol that is implemented to transmit information related to the link state to all other routers in the same area. In other words, the routers can recognize whether the link state is changed through the OSPF. The change of the link state should be applied to the RSVP. In the present invention, the change of the link state caused by the OSPF is considered during the resource reservation according to the RSVP.

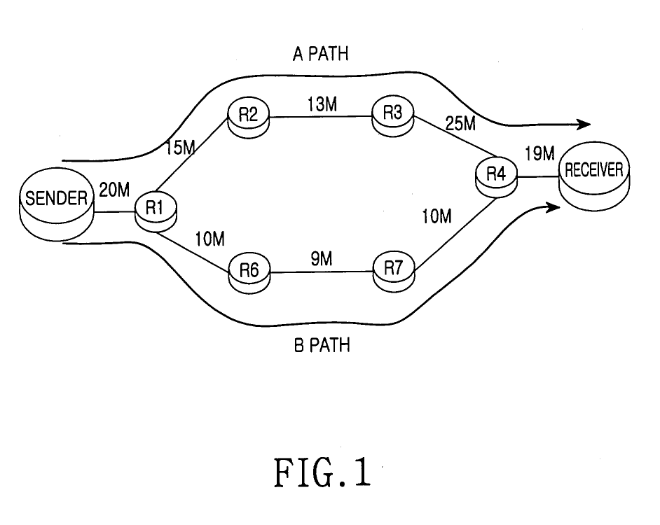

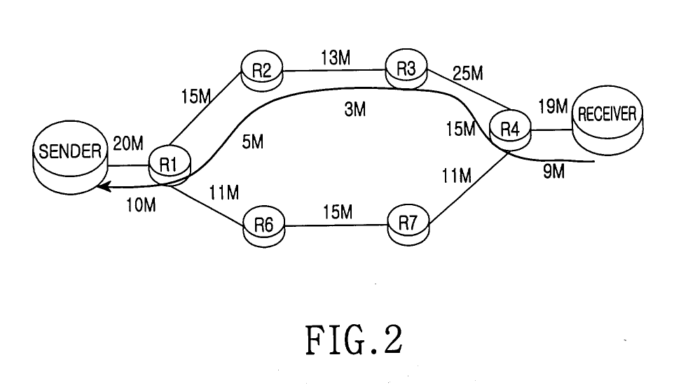

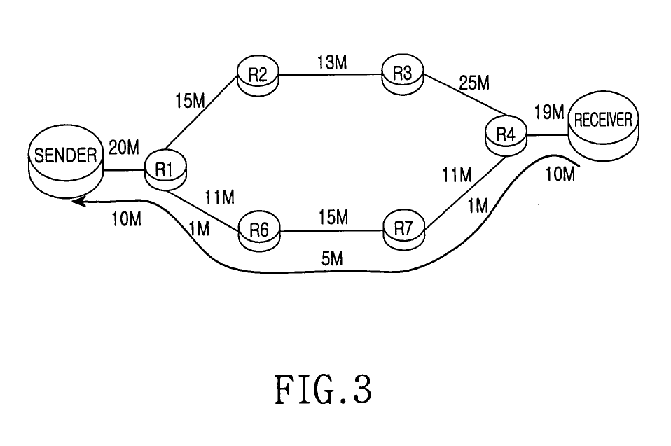

FIG. 1 is a view illustrating a message flow for requesting a resource reservation between a sender and a receiver, FIG. 2 is a view illustrating a message flow for responding to the request for resource reservation, and FIG. 3 is a view illustrating a message flow for responding to the request for resource reservation by reflecting the link state changed according to the open shortest path first protocol (OSPF).

First, referring to FIG. 1, the sender, for instance, requests a resource reservation of 10 Mbps to the receiver. This request for resource reservation is performed through all possible paths from the sender to the receiver, for example, through an A path and a B path as illustrated in FIG. 1. In FIG. 1, numerals designated for routers (that is, 20M, 15M, 13M, 25M, and 19M on the A path, and 20M, 10M, 9M, 10M, and 19M on the B path) indicate available resource information (i.e., bandwidth and Mbps) in links for the corresponding routers.

The receiver selects the A path with reference to the available resource information of the routers on all the paths, and informs the sender that resource reservation of 10 Mbps is possible through the A path, as shown in FIG. 2. Then, the routers R1, R2, R3, and R4 on the A path set the resource reservation to as much as 10 Mbps. The sender determines whether the use of the requested resource is possible, and thus starts to transmit data packets through the A path.

During the above-described data flow, if the routers R1, R2, R3, and R4 on the A path set the resource reservation, the link states (i.e., bandwidths) are changed to 10M, 5M, 3M, 15M, and 9M, as shown in FIG. 2. In a typical communications network, it is known that routers support an open shortest path first protocol (OSPF). According to this OSPF, a router that detects the change of a routing table or variation in a network immediately reports this to all routers in the same area so that all routers have the same routing table information.

Then, the routers R1, R2, R3, and R4 report the change of the link state to other routers, including the sender and the receiver, in accordance with the OSPF. Due to this change of the link state, the B path (not the A path) can be selected as an optimum path between the sender and the receiver. Then, the sender receives the change of link state, and again requests the resource reservation of 10 Mbps to the receiver in order to re-perform the resource reservation procedure.

The receiver selects the B path in response to the second request for resource reservation, and, as shown in FIG. 3, reports that the resource reservation is possible in a direction opposite to that of the B path using a resource reservation response (RESV) message, as shown in FIG. 3. Then, the routers R1, R6, R7, and R4 on the B path set the resource reservation to as much as 10 Mbps, and the sender determines whether the use of the requested resource is possible, and transmits the data packets through the B path. During this procedure, the reserved resources on the A path are withdrawn.

Then, the routers R1, R6, R7, and R4 on the B path set the resource reservation and subsequently report the change of the link state in accordance with the OSPF, while the routers R1, R2, R3, and R4 on the A path also report the change of the link state. As a result, an unnecessary repetition of the resource reservation procedure as illustrated in FIGS. 2 and 3 (i.e., a ping-pong phenomenon) may be endlessly repeated.

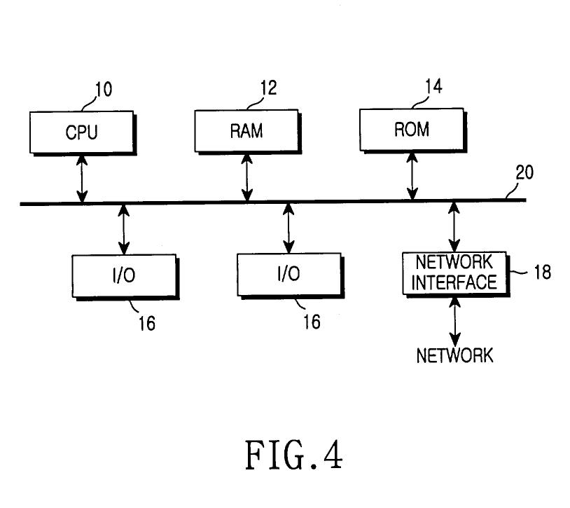

FIG. 4 is a block diagram illustrating the internal construction of a router in a communication network that supports an RSVP. This construction can be also applied to a sending host and a receiving host.

The construction illustrated in FIG. 4 includes a central processing unit (CPU) 10, a random access memory (RAM) 12, a read only memory (ROM) 14, diverse input/output (I/O) devices 16, a network interface 18, and a bus 20 for connecting them together. In the case of a sending/receiving host, the network interface 18 is used to connect to the router for the network connection, and in the case of a router, the network interface 18 is used to connect to the sending/receiving host or to another router. FIG. 4 shows an example of the construction of the router, but it should be noted that the present invention is not limited to this construction.

Hereinafter, the RSVP will be explained. The resource reservation according to the RSVP is classified into the following three styles:

a wildcard-filter (WF) style which shares only a single reservation information with respect to all the data flow from senders;

a fixed-filter (FF) style which uses a single reservation information with respect to the data flow from senders; and

a shared-explicit (SE) style which uses shared signal reservation information with respect to the data flow, that is determined by a receiver, from senders.

The message mainly used in the RSVP is classified into two types, a path message and an RESV message, defined as follows.

Path message: In the description, the path message is called a resource reservation request message. This message is sent so that the sender informs the receiver of the characteristic of the data flow and the resource required for the QoS, and includes the following information:

a sender template which identifies information such as an Internet protocol address of the sending host, port number, protocol identifier (ID), etc;

a sender tspec which indicates the traffic characteristic (i.e., requested bandwidth) of the data flow; and

an adspec which indicates one-path with advertising (OPWA) information.

RESV message: In the description, the RESV message is called a resource reservation response message. This message is in response to the resource information requested by the path information, and is used so that the receiver or the routers on the path can indicate and send the resource information that can be reserved.

The resource reservation procedure by the RSVP is as follows.

The communication network to be explained hereinafter includes a sender, at least one receiver, and at least one router located between the sender and the receiver. Here, the sender is a transmitting host that is a transmitting router or has a routing function directly connected to the transmitting host, and the receiver is a receiving host that is a receiving router or has a routing function directly connected to the receiving host. The sender, the receiver and the router are all provided with an RSVP handler.

1. The sender sends a path message for requesting a resource reservation along possible paths with reference to a prepared routing table.

2. The routers located on the paths from the sender to the receiver receive the path message, and then record available resource information to transfer the resource information to the receiver.

3. The receiver that received the path message determines the resource information, which can be reserved with reference to the resource information recorded in the path message, and sends an RESV message, including a result of determination, in a direction opposite to the that of reception of the path message.

4. The routers located on the paths from the receiver to the sender and receiving the RESV message set the resource reservation according to the information indicated in the RESV message, and then transfer the RESV message to the sender.

5. The sender that received the RESV message determines whether the use of the resource is possible to the extent that indicated in the RESV message, and starts the data flow to the receiver.

According to the present invention, in the data flow as described above, the change of the link state generated due to the resource reservation is considered temporary. For this, the sender drives a timer set for a predetermined time when requesting the resource reservation, and ignores the change of the link state that is generated before the expiration of the set time of the timer. If the data flow is completed and the reserved resource is withdrawn, the resource of the link due to the resource reservation is recovered, and the timer is terminated. If the change of the link state is detected after the expiration of the timer, this is considered to not be a change of the link state caused by the resource reservation, and re-reservation of the resource is attempted.

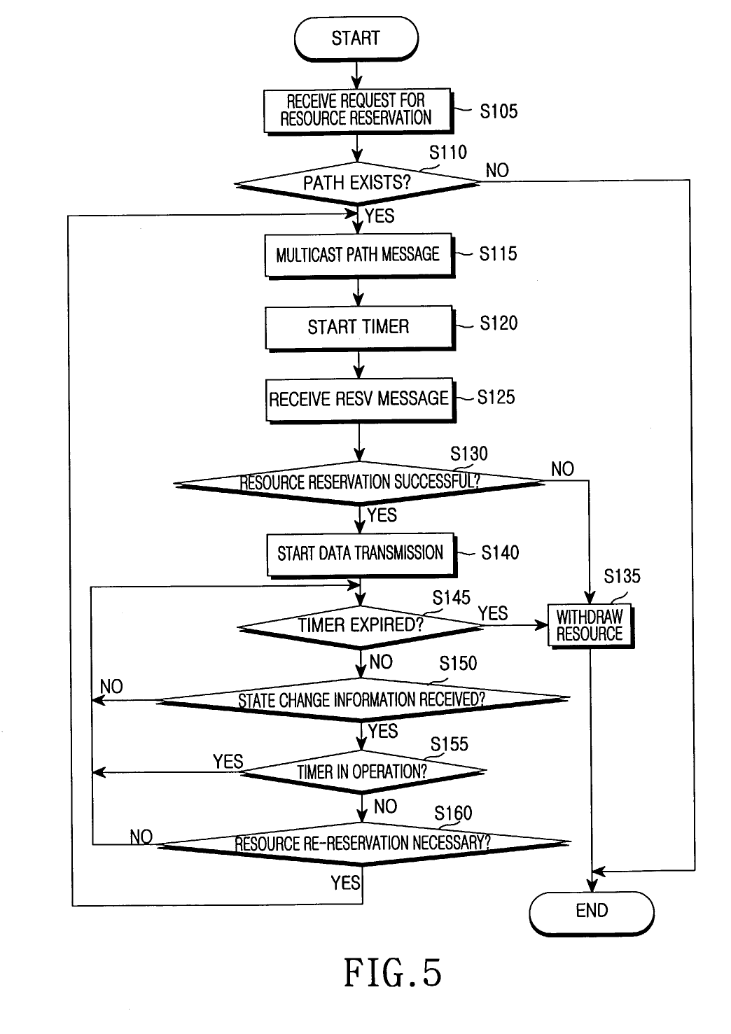

FIG. 5 is a flowchart illustrating a procedure for performing data communication using an RSVP according to the present invention. Here, it is to be noted that the above procedure is performed by the sender who intends to transmit data through the communication network. Hereinafter, it is assumed that the sender is a transmitting router that connects the transmitting host with the communication network, and the receiver is a receiving router that connects the receiving host with the communication network. Each of the routers is provided with a routing table that includes information on available transmission paths to other routers, and the routing table is updated by a routing protocol.

Referring to FIG. 5, if data to be transmitted from the transmitting host to the receiving host is produced, the transmitting host requests the sender (i.e., the transmitting router) for the resource reservation of a desired bandwidth. The sender, after receiving the resource reservation request (step S105), determines whether at least one available transmission path to the receiver (i. e., receiving router) exists with reference to the routing table (step S 110). If it is determined that the available path does not exist, the sender concludes that the data transmission has failed, reports the failure to the transmitting host, and terminates the data flow.

If it is determined that the available path does exist at step S110, the sender multicasts the path message for requesting the resource reservation through all of the paths searched in the routing table (step S115). As described above, the path message includes the IP address of the sender, the port number, the protocol ID (especially, REVP identifier), the request bandwidth, etc. After the path message is transmitted, a timer set for a predetermined time is started (step S120).

Here, the timer is used to prevent the endless repetition phenomenon of the resource reservation procedure. In the preferred embodiment, the timer receives the RESV message regarding the path message (i.e., completes the resource reservation), and is set for a time period sufficient to complete the requested data transmission. As another example, the timer may be set for a time period longer than that requested by the transmitting host, and in this case, the transmitting host can secure a safe data transmission during the desired time period. Accordingly, the timer can be set diversely for a time period from several minutes to several days.

As described above, the routers, which have plural available paths from the sender to the receiver, receive the path message, and then record and transmit the useable bandwidth to the receiver. The receiver selects the optimum path with reference to the bandwidth information recorded in the path message received through the plural paths, and sends the RESV message to the sender through a selected path in response to the path message. The RESV message includes the possible resource reservation information of the selected path, and the routers on the selected path that transfers the RESV message set the resource reservation according to the resource reservation information.

If the RESV message is received in response to the path message (step S125), the sender determines whether the resource reservation sufficient for the data transmission requested by the transmitting host is successfully performed (step S130). If it is determined that the resource reservation does not fully satisfy the data transmission requested by the transmitting host, the sender concludes that there is a failure of the resource reservation, reports this to the transmitting host, and withdraws the reserved resource (step S135). If it is determined that the resource reservation is successful, the sender commences data transmission through the path indicated by the RESV message (step S140). If the timer is normally terminated (i.e., it expires after the data transmission starts—step S145), the sender withdraws the reserved resource (step S135), and terminates the data transmission.

Meanwhile, if information on the change of the link state is received through the OSPF after the data transmission starts (step S150), the sender determines whether the timer that started at step S120 is still in operation (step S 155). If the timer is in operation, the sender ignores the information on the change of the link state, and continues the data transmission (return to step S145).

On the contrary, if the timer is already expired, the sender determines whether the re-reservation of the resource is necessary with reference to the information on the change of the link state (step S160). If it is determined that the resource of the path is not sufficient for the continuous data transmission, or the resource of another path is more suitable for the data transmission by the RESV message received at step S125, the sender concludes that the re-reservation of the resource is necessary, and returns to step S115. On the contrary, if the re-reservation of the resource is not necessary, the sender continues the data transmission (return to steps S145).

An example of the resource reservation procedure according to the present invention will be explained with reference to FIGS. 1 and 2.

1. The sender multicasts the path message for requesting the resource reservation of 10M to the receiver, as shown in FIG. 1, and then starts the timer which is set for the predetermined time. Here, “multicasting” means simultaneous transmission of the path message to the plural receivers through all the possible paths (illustrated as A and B paths).

2. The receiver that received the path message selects the A path, and then transmits the RESV message for the information on the resource of 10M that can be reserved in a direction opposite to that of the A path, as shown in FIG. 2.

3. The routers R1, R2, R3, and R4 on the A path that received the RESV message set the resource reservation to as much as that indicated in the RESV message, and transfer the RESV message to the sender.

4. The sender that received the RESV message determines that the use of the resource requested through the A path is possible, and starts the data flow through the A path.

5. The routers R1, R2, R3, and R4 on the A path detect the change of the link state due to the set of the resource reservation, and broadcast the state change information to the adjacent routers.

6. The sender ignores the received state change information, and does not perform the re-reservation of the resource until the timer, set as described above, expires.

As described above, according to the present invention, the following effects are obtained. The present invention reduces the load on the routers and the network by not transferring unnecessary link state information on the network during the resource reservation, and removes the phenomenon of unnecessary repetition (i.e., the “ping-pong” phenomenon) in the resource reservation procedure, thereby enabling stable operation of the network. In addition, the present invention can be easily implemented on a communication network having typical structure by merely changing the structure of the transmitting router.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method of performing data communication using a resource reservation in a communication network, the method comprising:
a first step of starting a timer set for a predetermined time when a link resource for data transmission from a sender to a receiver is reserved in the communication network;
a second step of determining whether the timer is in operation when a link state of the communication network is changed after the link resource is reserved; and
a third step of ignoring change of the link state and continuing data transmission when it is determined in the second step that the timer is in operation.

2. The method as claimed in claim 1, further comprising a fourth step of reserving again the link resource for the data transmission when it is determined in the second step that the set time of the timer has expired.

3. The method as claimed in claim 2, wherein the timer is set for a sum of a time required for reservation of the link resource for the data transmission and a time required for the data transmission.

4. The method as claimed in claim 2, wherein the timer is set for an amount of time required by the sender.

5. The method as claimed in claim 1, wherein the timer is set for a sum of a time required for reservation of the link resource for the data transmission and a time required for the data transmission.

6. The method as claimed in claim 1, wherein the timer is set for an amount of time required by the sender.

7. The method as claimed in claim 1, wherein the first step comprises the steps of:
transmitting to the communication network a message for requesting resource reservation for the data transmission from the sender to the receiver;
starting the timer, set for predetermined time periods, after transmitting the message for requesting the resource reservation; and
starting the data transmission when a response message to the message for requesting the resource reservation is received from the receiver.

8. The method as claimed in claim 1, further comprising the steps, prior to the first step, of:
determining whether a path exists in the communication network; and
multicasting a path message when it is determined that the path exists.

9. The method as claimed in claim 1, further comprising the steps, between the first step and the second step, of:
receiving a resource reservation response (RESV) message;
determining whether a resource reservation is successful; and
starting data transmission when it is determined that the resource reservation is successful.

10. The method as claimed in claim 9, further comprising the steps, after the step of starting the data transmission, of:
determining whether the timer is in operation; and
withdrawing the link resource when it is determined that the timer is in operation.

11. The method as claimed in claim 10, further comprising the step, when it is determined that the timer is not in operation, of receiving state change information.

12. The method as claimed in claim 1, further comprising the steps, when it is determined in the second step that the timer is not in operation, of:
determining whether resource re-reservation is necessary; and
continuing the data transmission when it is determined that the resource re-reservation is not necessary.

13. A method of performing data communication using a resource reservation in a communication network, the method comprising the steps of:
transmitting to the communication network a message for requesting the resource reservation for data transmission to a receiver;
starting a timer set for predetermined time periods after transmitting the message for requesting the resource reservation;
starting the data transmission when a response message in response to the message for requesting the resource reservation is received from the receiver;
determining whether the timer is in operation when a message reporting change of a link state of the communication network is received after starting the data transmission; and
ignoring the message reporting the change of the link state of the communication network and continuing the data transmission when it is determined that the timer is in operation.

14. The method as claimed in claim 13, further comprising the step of retransmitting to the communication network the message for requesting the resource reservation in order to re-reserve the link resource for the data transmission when it is determined that the timer is not in operation.

15. The method as claimed in claim 14, wherein the timer is set for a sum of a time required for reservation of the link resource for the data transmission and a time required for the data transmission.

16. The method as claimed in claim 14, wherein the timer is set for an amount of time required by the sender.

17. The method as claimed in claim 13, wherein the timer is set for a sum of a time required for reservation of the link resource for the data transmission and a time required for the data transmission.

18. The method as claimed in claim 13, wherein the timer is set for an amount of time required by the sender.

19. The method as claimed in claim 13, further comprising the steps, between the step of starting the timer and the step of starting the data transmission, of:
determining whether the resource reservation is successful; and
withdrawing a resource when it is determined that the resource reservation is not successful.
